(19) United States
(12) Patent Application Publication
(10) Pub. No.: US 2008/0249805 A1
(43) Pub. Date: Oct. 9, 2008

(54) SMART CLINICAL DATA CLIPBOARD

(76) Inventor: Amit Kumar Singh, Edison, NJ (US)

Correspondence Address: PATRICK W. RASCHE (12553 - 1000), ARMSTRONG TEASDALE LLP, ONE METROPOLITAN SQUARE, SUITE 2600, ST. LOUIS, MO, 63102-2740, US

(21) Appl. No.: 11/696,328

(22) Filed: Apr. 4, 2007

(51) Int. Cl. G06F 19/00

(52) U.S. Cl. 705/3

(57) ABSTRACT

A method for quickly providing accurate data to a user includes creating a list of at least one subject characteristic, collecting subject data corresponding to the at least one subject characteristic in a clipboard application and accessing an integrated application interface requiring selected data from the subject data and entering the selected data in the integrated application.

### BACKGROUND OF THE INVENTION

This invention relates generally to clinical trials and, more particularly, to methods and systems for quickly providing accurate patient data to health care professionals.

Clinical trials are research studies designed to answer specific questions about new medical therapies or new ways of using known therapies. Generally, clinical trials are used to determine whether new drugs or treatments are safe and effective. Usually, individuals volunteer to become clinical trial patients who participate in clinical trials. Health care professionals involved with clinical trials need to remember and perhaps carry patient information used in their integrated applications. Quickly and easily accessing accurate patient data through integrated clinical applications may improve the efficiency and effectiveness of health care professionals during clinical trials.

### BRIEF DESCRIPTION OF THE INVENTION

In one aspect, a method for quickly providing accurate data to a user is provided. The method includes creating a list of at least one subject characteristic, collecting subject data corresponding to the at least one subject characteristic in a clipboard application and accessing an integrated application interface requiring selected data from the subject data and entering the selected data in the integrated application.

In another aspect, a computer system for quickly providing accurate data to a user is provided. The system includes a server configured to create a list of at least one patient characteristic, collect patient data corresponding to the at least one patient characteristic in an application, access an integrated application interface requiring selected data from the patient data and enter the selected data.

In yet another aspect, a computer system is provided including a server configured to simultaneously operate a plurality of integrated clinical applications, create a list of at least one patient characteristic, collect patient data corresponding to the at least one patient characteristic in an application, access an integrated application interface requiring selected data from the patient data and enter the selected data.

### BRIEF DESCRIPTION OF THE DRAWINGS

FIG. 1 is a simplified block diagram of a clinical computer system in accordance with one embodiment of the present invention;

FIG. 2 is an expanded version block diagram of an example embodiment of a server architecture of the clinical computer system; and

FIG. 3 is an exemplary embodiment of a user interface displaying a clinical clipboard.

### DETAILED DESCRIPTION OF THE INVENTION

The methods and systems described herein facilitate enhancing quick, easy and accurate access to information used in clinical trial computer system integrated applications. The methods and systems described herein are believed to be applicable to many different businesses for accessing information. The example embodiment described herein is the medical clinical trial business. Although the medical clinical trial business is the example business described herein, the invention is in no way limited to the medical clinical trial business.

Exemplary embodiments of systems and processes that facilitate providing integrated network-based electronic information regarding clinical trials are described below in detail. The systems and processes facilitate, for example, quickly, easily and accurately accessing electronic information using a clinical system. A technical effect of the systems and processes described herein include at least one of permitting clinical health care professionals to create a set of predefined lists for each patient. More specifically, in the example embodiment, clinical health care professionals utilize the methods and systems of the example embodiment to quickly access a list of data created about each patient, such as, but not limited to, the subject's age, height, weight, name, address, phone number, insurance information, allergies, current maladies and current medications. It should be appreciated that patient data lists may contain any information regarding a clinical patient that is necessary for conducting a clinical trial and is related to patient documentation. Thus, allowing health care professionals to provide better and more effective care. Additionally, creating lists of patient data facilitates pre-populating required data fields in patient-related documentation, thus increasing a health care professional's ability to provide better and more effective care.

In the exemplary embodiment, the clinical system is utilized to collect, track and display clinical trial patient data, such as, but not limited to, patient name, allergies and major illnesses. At least some of the parties that may be involved in these systems and processes include clinical trial patients, health care professionals and clinical trial facilities. The term clinical trial patients refers to the individuals who voluntarily agree to take part in clinical trials. Health care professionals are individuals that provide medical services to clinical trial patients during the clinical trial, and include, but are not limited to, physicians, nurses and pharmacists. Clinical trial facilities include any entity that may provide the facilities for conducting a clinical trial, such as, but not limited to, hospitals and physicians' offices.

In the example embodiment, users of the clinical system are able to perform many tasks, such as, but not limited to, quickly and accurately pre-populating data fields in integrated clinical applications using application specific data imported from a clinical clipboard.

It should be appreciated that although the example discussed above is from the medical clinical trial business, the clinical system may be used in any other business or field of endeavor involving subject data and documentation. However, it should be further appreciated that other businesses or organizations may define a different set of criteria for subject data, and that for each business, subject data will be different.

In one embodiment, a computer program is provided, and the program is embodied on a computer readable medium and utilizes a Structured Query Language (SQL) with a user interface for administration and an interface for standard input and generating reports. In an exemplary embodiment, the system is run on a business-entity intranet. In a further exemplary embodiment, the system is run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

In the example embodiment, a clinical clipboard interface records and tracks data generated for each patient in a clinical trial and provides quick access to accurate and proper data that is imported into integrated clinical applications on an application specific basis. The data are stored electronically in the clinical system as part of the clinical trial documentation. A method for facilitating access to patient data is provided that facilitates increasing the effectiveness of health care provided by health care professionals. Furthermore, the exemplary embodiment may be made context aware to load application specific data into integrated clinical applications.

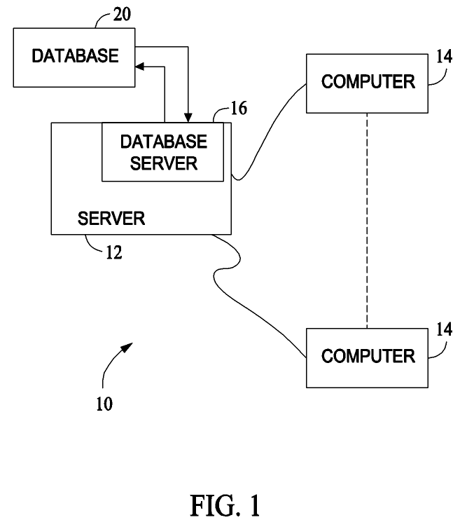

FIG. 1 is a simplified block diagram of a clinical system 10 including a server system 12, and a plurality of client sub-systems, also referred to as client systems 14, connected to server system 12. Computerized modeling and grouping tools, as described below in more detail, are stored in server 12 and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

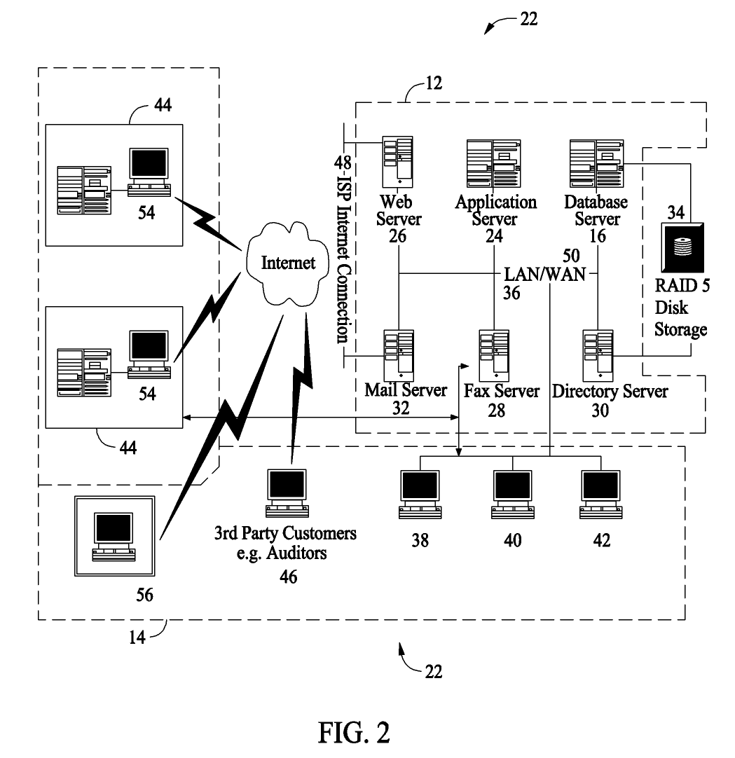

FIG. 2 is an expanded block diagram of an exemplary embodiment of a server architecture of a clinical system 22. Components in clinical system 22, identical to components of system 10 (shown in FIG. 1), are identified in FIG. 2 using the same reference numerals as used in FIG. 1. Clinical system 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., clients/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access clinical system 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

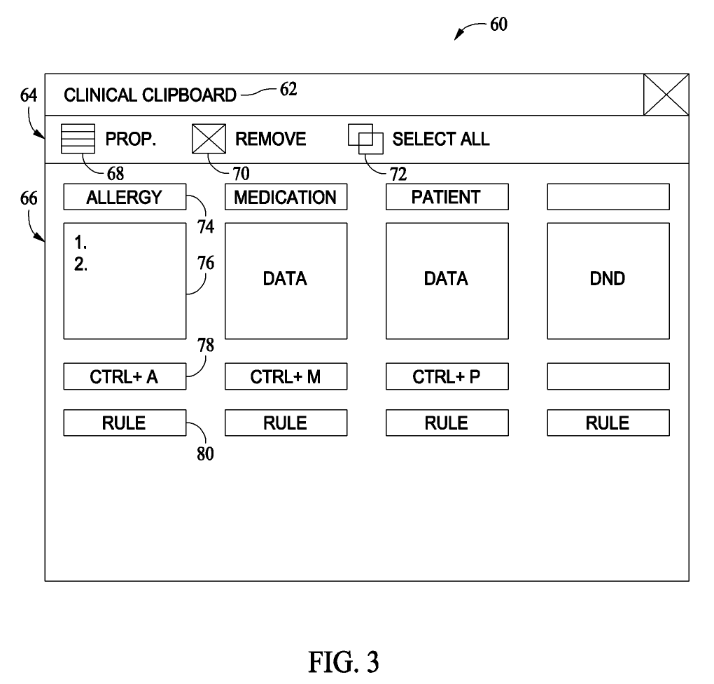

FIG. 3 is an exemplary embodiment of a user interface displaying a clinical clipboard application 60 used with clinical system 22. More specifically, clinical clipboard system 60 includes a title section 62, a selection section 64 and a patient data section 66. Title section 62 contains the title “Clinical Clipboard”. Selection section 64 includes an add data option 68, a remove data option 70 and a select all data option 72. Add data option 68 facilitates entering patient data into patient data section 66. Remove data option 70 facilitates removing selected patient data from patient data section 66. It should be appreciated that although patient data may be added and removed from patient data section 66 in the exemplary embodiment using add data option 68 and remove data option 70, respectively, in other embodiments, patient data may also be added and removed from patient data section 66 by dragging and dropping data. Moreover, it should be appreciated that data may be dragged or dropped at any time and health care professionals can define whether or not clipboard application 60 should be pre-populated with patient data. Select all data option 72 facilitates simultaneously selecting all of the fields contained in patient data section 66.

Patient data section 66 includes and displays information about a single patient. Furthermore, it should be understood that clinical system 22 may include data for many different patients that may also be displayed on clipboard application 60. In the exemplary embodiment, patient data section 66 includes at least one data heading 74, and corresponding patient data 76, shortcut keys 78 and applicable rules 80. Patient data section 66 displays a snapshot of patient information that includes all or part of a patient's data 76. More specifically, applications integrated within system 22 communicate with clinical clipboard application 60 such that each patient snapshot displayed on data section 66 may be used in any of the clinical applications integrated within clinical system 22.

Health care professionals create a list of patient characteristics and identify each characteristic using data headings 74. In the exemplary embodiment, data headings 74 correspond to patient characteristics, such as, but not limited to, patient allergies, patient medications and patient names. It should be appreciated that although the exemplary embodiment is described as including three characteristics, in other embodiments, any number and type of patient characteristics may be identified and entered into clinical clipboard application 60. Moreover, it should be appreciated that any number and type of patient characteristics may be added and removed from clinical clipboard application 60 during a clinical trial. Data headings 74 also indicate the type of patient information contained in patient data 76. For example, if data heading 74 is titled “allergies”, patient data section 76 contains data corresponding to a patient's allergies. Health care professionals are concerned about patient allergies because care should not be prescribed that triggers an allergic reaction or compounds an allergic reaction. Shortcut keys 78 represent keystrokes on a standard computer keyboard, that if pressed, automatically select a heading 74 and corresponding patient data 76. For example, to access data regarding a patient's allergies, a health care professional presses a control button and the capital “A” simultaneously on a keyboard.

Patient data 76 may include any kind of patient data, such as, but not limited to, images and user typed data. Moreover, it should be appreciated that in the exemplary embodiment, clinical system 22 encrypts patient data 76 to maintain patient privacy.

Clinical clipboard application 60 also includes rules 80 that correspond to data headings 74 and that are also part of a decision support system. Each rule 80 is written by a health care professional and is drafted to generate an output, or outcome, such as, but not limited to, notification that a patient isn't responding well to medication, a method of treatment, suggested drug dosages, and notifications that a patient is not to receive certain medications. Rules 80 may include instructions for administering a variety of medical therapies corresponding to various maladies. For example, rules 80 for a patient's allergies may include instructing a health care professional to administer certain drugs while prohibiting administration of other drugs. It should be appreciated that rules 80 may include any type of instruction, relating to any kind of malady or issue, that enables clinical system 22 and clipboard 60 to function as described herein.

It should be understood that changing the patient context refreshes the information in clipboard application 60. More specifically, when a new patient is chosen, the new patient's data headings 74, patient data 76, keys 78 and rules 80 are updated accordingly.

It should be understood that clinical clipboard application 60 communicates with applications integrated within clinical system 22, and that patient data 76 can be used anywhere and in any of the clinical applications integrated within clinical system 22. Clinical clipboard application 60 is also context aware to automatically load application specific data for health care professionals. More specifically, applications integrated within system 22 communicate with clinical clipboard application 60 so that when particular text is entered into an integrated application, the appropriate data from clinical clipboard application 60 is automatically entered into the integrated application. For example, a health care professional may type a patient's name into an integrated application about allergies. System 22 automatically identifies the text of the patient's name and retrieves the appropriate information relating to the patient's allergies from clinical clipboard application 60, as well as any other clipboard application 60 information required by the allergy application.

It should be understood that previously entered data may be previewed at any time before entering additional data. For example, a health care professional may preview previously entered allergy data prior to entering additional allergy data. Moreover, it should be appreciated that any application integrated within clinical system 22 that includes a text area may obtain data from clipboard 60. Specifically, as a health care professional enters text in the text area of an application, system 22 will provide suggestions relating to the data as the data is entered. After the first two or three characters have been entered, system 22 attempts to match the entered characters with characters of text in clipboard 60. For example, if a health care professional begins entering characters of the word “prescription”, system 22 may prompt the user with options, such as, but not limited to, “prescribe”, “prevent” and “prescription”. The health care professional may choose the option corresponding to the desired word, in this case “prescription”, thus saving the health care professional time.

A predefined set of module, or application, specific data can be created based on the roles. That is, the data presented in a specific module varies based on the permissions granted to each individual's role in the health care process. More specifically, doctors, nurses and system administrators may have different access permissions within the computer system, and may have correspondingly different data entered for each module. For example, a patient's allergy and medical data may be accessible by nurses and doctors for proper treatment. However, system administrators are not granted access to this information because the system administrators do not use the patient's medical information.

In the example embodiment, a clinical clipboard application records and tracks a list of patient data. More specifically, a method for quickly providing accurate patient data while reducing data entry time for health care professionals is provided where a user types predetermined text into an integrated clinical application interface and application specific data is automatically imported to the clinical application from the clipboard. As a result, health care professionals quickly receive accurate patient data and do not spend valuable time repeatedly entering patient data into different integrated application interfaces. Consequently, health care professionals can devote more time to providing a higher quality of medical care, thus improving their effectiveness.

While the invention has been described in terms of various specific embodiments, the description of the various embodiments is illustrative only and is not to be construed as limiting the invention. Various other modifications and changes may occur to those skilled in the art will without departing from the spirit and scope of the invention.

What is claimed is:

1. A method for quickly providing accurate data to a user, said method comprising:
creating a list of at least one subject characteristic;
collecting subject data corresponding to the at least one subject characteristic in a clipboard application; and
accessing an integrated application interface requiring selected data from the subject data and entering the selected data in the integrated application.

2. A method in accordance with claim 1 further comprising importing the selected data from the clipboard application.

3. A method in accordance with claim 1 wherein accessing an integrated application interface requiring selected data from the subject data further comprises implementing the integrated application to be context aware.

4. A method in accordance with claim 3 wherein implementing the integrated application to be context aware further comprises recognizing identifying text and entering the selected data that corresponds to the identifying text.

5. A method in accordance with claim 1 wherein collecting subject data corresponding to the at least one subject characteristic in an application further comprises forming a clipboard application including at least one subject data heading, subject data corresponding to the at least one subject heading and at least one rule corresponding to the at least one subject heading.

6. A method in accordance with claim 5 wherein forming a clipboard application further comprises updating the at least one subject heading, subject data corresponding to the at least one patient heading and the at least one rule corresponding to the at least one subject leading when a new subject name is entered into the clipboard.

7. A method in accordance with claim 1 wherein collecting subject data further comprises collecting data regarding a patient's allergies, medications and name.

8. A method in accordance with claim 1 further comprising pressing shortcut keys to select a subject data heading and subject data.

9. A computer system for quickly providing accurate data to a user, said system comprising a server configured to:
create a list of at least one patient characteristic;
collect patient data corresponding to the at least one patient characteristic in an application;
access an integrated application interface requiring selected data from the patient data; and
enter the selected data.

10. A system in accordance with claim 9 wherein said server further configured to import the selected data from a clipboard application.

11. A system in accordance with claim 9 wherein said server further configured to implement an integrated application as context aware.

12. A system in accordance with claim 11 wherein said server further configured to recognize identifying text and enter the selected data that corresponds to the identifying text.

13. A system in accordance with claim 9 wherein said server further configured to form a clipboard application including at least one patient data heading, patient data corresponding to the at least one patient data heading and at least one rule corresponding to the at least one patient data heading.

14. A system in accordance with claim 13 wherein said server further configured to update the at least one patient data heading, patient data corresponding to the at least one patient data heading and the at least one rule corresponding to the at least one patient data heading when a new patient name is entered into a clipboard application.

15. A system in accordance with claim 9 wherein said server further configured to collect data regarding a patient's allergies, medication's and name.

16. A computer system comprising a server configured to:
simultaneously operate a plurality of integrated clinical applications;
create a list of at least one patient characteristic;
collect patient data corresponding to the at least one patient characteristic in an application;
access an integrated application interface requiring selected data from the patient data; and
enter the selected data.

17. A computer system in accordance with claim 16 wherein said server further configured to import said selected data from a clipboard application.

18. A computer system in accordance with claim 16 wherein said server further configured to implement the integrated application as context aware.

19. A computer system in accordance with claim 18 wherein said server further configured to recognize identifying text and enter the selected data that corresponds to the identifying text.

20. A computer system in accordance with claim 16 wherein said server further configured to form a clipboard application including at least one patient data heading, patient data corresponding to the at least one patient data heading and at least one rule corresponding to the at least one patient data heading.
